(19) United States
(12) Patent Application Publication
(10) Pub. No.: US 2015/0042839 A1
(43) Pub. Date: Feb. 12, 2015

(54) DISTANCE MEASURING APPARATUS, IMAGING APPARATUS, AND DISTANCE MEASURING METHOD

(71) Applicant: Canon Kabushiki Kaisha, Tokyo (JP)

(72) Inventors: Satoru Komatsu, Yokohama-shi (JP); Keiichiro Ishihara, Yokohama-shi (JP)

(21) Appl. No.: 14/451,580

(22) Filed: Aug. 5, 2014

(30) Foreign Application Priority Data
Aug. 12, 2013 (JP) 2013-167656

(51) Int. Cl. G06T 7/00; G06K 9/46; H04N 5/232

(52) U.S. Cl. CPC G06T 7/0022; H04N 5/23212; G06K 9/4642
USPC 348/222.1; 382/106

(57) ABSTRACT

A distance measuring apparatus that calculates an subject distance from a plurality of images having different degrees of a blur, comprises an area setting unit configured to set ranging target areas in corresponding coordinate positions in the plurality of images, respectively; a feature value calculating unit configured to calculate, for each of the ranging target areas set in the plurality of images, a feature value of the ranging target area; and a distance calculating unit configured to calculate an subject distance in the ranging target area based on a plurality of feature values calculated for the ranging target areas.

### BACKGROUND OF THE INVENTION

1. Field of the Invention

The present invention relates to a distance measuring apparatus that measures a distance to a subject using an image.

2. Description of the Related Art

Various methods have been proposed to measure a distance to a subject (subject distance) based on an image acquired by an imaging apparatus, and the depth from defocus (DFD) method is one such method. The DFD method is a method of acquiring a plurality of images having different degrees of a blur by changing the parameters of an imaging optical system, and estimating a subject distance based on the quantity of blur included in the plurality of images. The DFD method allows calculating the distance using only one imaging system, therefore the DFD method can easily be incorporated into the apparatus.

### SUMMARY OF THE INVENTION

In the case of the DFD method using a real space image, it is necessary to accurately match the positions of a plurality of photographed images. If the positions of the plurality of images are not aligned, even if the misalignment is in a sub-pixel unit, the accuracy of the measurement deteriorates, and an accurate distance cannot be acquired.

To handle this problem, in an apparatus according to Japanese Patent No. 2756803 or Japanese Patent Application Laid-Open No. 2000-199845, the DFD method is applied not to a real space image but to a frequency space image, thereby the distance is measured and focusing is performed. Such a method has an advantage that misalignment is less compared with the conventional DFD method using the real space image, but still has a problem in that the computational amount increases.

With the foregoing in view, it is a subject of the present invention to provide a technique, to measure a distance with little misalignment and small computational amount, to a distance measuring apparatus which measures a distance by the DFD method.

The present invention in its one aspect provides a distance measuring apparatus that calculates a subject distance from a plurality of images having different degrees of a blur, comprises an area setting unit configured to set ranging target areas in corresponding coordinate positions in the plurality of images, respectively; a feature value calculating unit configured to calculate, for each of the ranging target areas set in the plurality of images, a feature value of the ranging target area; and a distance calculating unit configured to calculate a subject distance in the ranging target area based on a plurality of feature values calculated for the ranging target areas.

The present invention in its another aspect provides a distance measuring method for calculating a subject distance from a plurality of images having different degrees of a blur, comprises an area setting step of setting ranging target areas in corresponding coordinate positions in the plurality of images, respectively; a feature value calculating step of calculating, for each of the ranging target areas set in the plurality of images, a feature value of the ranging target area; and a distance calculating step of calculating a subject distance in the ranging target area based on a plurality of feature values calculated for the ranging target areas.

According to the present invention, a technique to measure a distance with little misalignment and small computational amount can be provided to a distance measuring apparatus which measures a distance by the DFD method.

Further features of the present invention will become apparent from the following description of exemplary embodiments with reference to the attached drawings.

### BRIEF DESCRIPTION OF THE DRAWINGS

FIG. 1 is a diagram depicting a configuration of an imaging apparatus according to Embodiment 1;

FIG. 2 is a flow chart depicting a flow of a distance measuring process according to Embodiment 1;

FIG. 3 is a flow chart depicting a flow of a distance map generation process according to Embodiment 1;

FIG. 4 is a graph showing an example of a defocus characteristic by variance;

FIG. 5 is a graph for discribing distance dependent values calculated in Embodiment 1;

FIG. 6 is a flow chart depicting a flow of a distance map generation process according to Embodiment 2;

FIG. 7 is a graph for describing distance dependent values calculated in Embodiment 2;

FIG. 8 is a flow chart depicting a distance map generation process according to Embodiment 3;

FIG. 9A and FIG. 9B are graphs for describing distance dependent values calculated in Embodiment 3;

FIG. 10 is a flow chart depicting a distance map generation process according to Embodiment 4; and

FIG. 11 is a graph for describing distance dependent values calculated in Embodiment 4.

### DESCRIPTION OF THE EMBODIMENTS

### Embodiment 1

An imaging apparatus according to Embodiment 1 will now be described with reference to the drawings. The imaging apparatus according to Embodiment 1 has a function to photograph a plurality of images, and to measure, using these images, a distance to a subject included in the images. Same composing elements are denoted with a same reference symbol, and redundant description thereof is omitted.

<System Configuration>

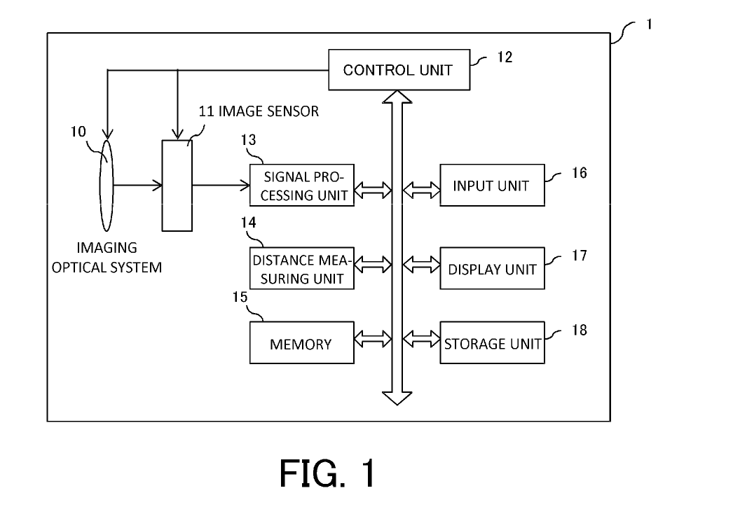

FIG. 1 is a diagram depicting a configuration of an imaging apparatus according to Embodiment 1.

The imaging apparatus 1 includes an imaging optical system 10, an image sensor 11, a control unit 12, a signal processing unit 13, a distance measuring unit 14, a memory 15, an input unit 16, a display unit 17 and a storage unit 18.

The imaging optical system 10 is an optical system constituted by a plurality of lenses, and forms an image of incident light on an image plane of the image sensor 11. The imaging optical system 10 is a variable-focal optical system, and can perform automatic focusing by an auto focus function. The type of auto focus may be either active or passive.

The image sensor 11 is an image sensor that includes such an image sensor as a CCD or a CMOS. The image sensor 11 may be an image sensor that has a color filter or a monochrome image sensor. The image sensor 11 may also be a three-plate type image sensor.

The signal processing unit 13 processes signals outputted from the image sensor 11. In concrete terms, A/D conversion of an analog signal, noise removal, demosaicing, brightness signal conversion, aberration correction, white balance adjustment, color correction or the like is performed. Digital image data outputted from the signal processing unit 13 is temporarily stored in the memory 15, and is then outputted to the display unit 17, the storage unit 18, the distance measuring unit 14 or the like, where desired processes are performed.

The distance measuring unit 14 calculates a distance in the depth direction to a subject included in an image (subject distance). Details on the distance measuring process will be described later. The distance measuring unit 14 corresponds to the area setting unit, the feature value calculating unit and the distance calculating unit according to the present invention.

The input unit 16 is an interface for acquiring the input operation from the user, and is typically a dial, button, switch, touch panel or the like.

The display unit 17 is a display unit constituted by a liquid crystal display, an organic El display or the like. The display unit 17 is used for confirming composition for photographing, viewing photographed or recorded images, displaying various setting screens or displaying message information, for example.

The storage unit 18 is a nonvolatile storage medium that stores, for example, photographed image data, and parameters that are used for the imaging apparatus 1. For the storage unit 18, it is preferable to use a large capacity storage medium which allows high-speed reading and writing. A flash memory, for example, is suitable.

The control unit 12 controls each unit of the imaging apparatus 1. In concrete terms, the control unit 12 performs auto focusing the auto focusing (AF), changes the focus position, changes the F value (diaphragm), loads and saves images, and controls the shutter and flash (not illustrated). The control unit 12 also measures the subject distance using an acquired image.

<How to Measure Subject Distance>

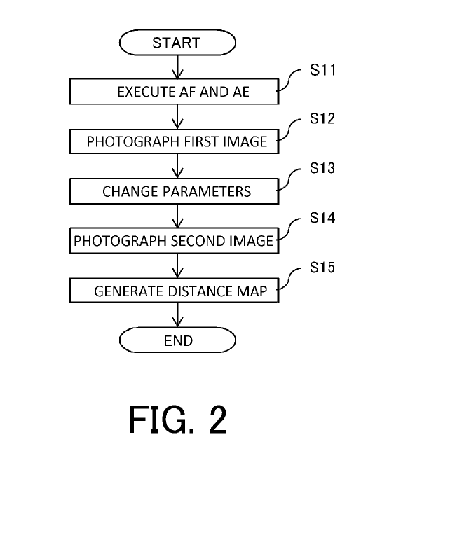

The distance measuring process performed by the imaging apparatus 1 will be described next in detail, with reference to FIG. 2 which is a flow chart depicting the process flow.

When the user starts photographing using the input unit 16, the control unit 12 executes auto focus (AF) and automatic exposure control (AE), and determines the focus position and the diaphragm value (F number) (step S11). Then in step S12, photographing is executed and an image is loaded from the image sensor 11.

When a first image is photographed, the control unit 12 changes the photographing parameters (step S13). The photographing parameters that are changed are at least one of the F number, the focus position and the focal length. For the parameter values, values that are stored in advance may be read and used, or values determined based on the information inputted by the user may be used.

When the photographing parameters are changed, the process moves to step S14, and a second image is photographed.

In this embodiment, the second image is photographed with a different focus position. For example, the first image is photographed such that the main subject is focused, and the second image is photographed with a different focus position such that the main subject is blurred.

When a plurality of images is photographed, it is preferable to make the shutter speed faster and the photographing interval shorter to measure the distance more accurately, since the influence of the camera shaking or subject movement is decreased as the shutter speed is faster and the photographing interval is shorter. However if sensitivity is increased to make the shutter speed faster, in some cases the influence of noise is increased more so than the influence of the camera shaking, hence an appropriate shutter speed must be set considering sensitivity.

If two images are photographed, the photographed images are processed by the signal processing unit 13 respectively so as to be images suitable for measuring a distance, and are temporarily stored in the memory 15. In this case, at least one of the photographed images may be signal-processed for viewing and stored in the memory 15.

In step S15, the distance measuring unit 14 calculates a distance map from two images for measuring the distances that are stored in the memory 15. The distance map is data that indicates the distribution of the subject distance in the image. The calculated distribution of the subject distance is displayed via the display unit 17, and is stored in the storage unit 18.

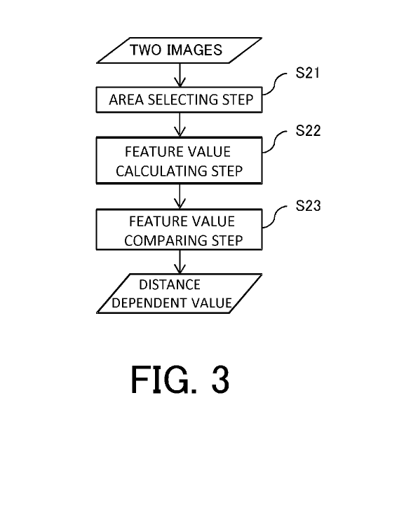

Now the process that the distance measuring unit 14 performs in step S15 (hereafter called “distance map generation process”) will be described. FIG. 3 is a flow chart depicting the flow of the distance map generation process according to Embodiment 1.

When two images photographed with different focus positions are inputted, the distance measuring unit 14 selects local areas having the same coordinate position in the two images, respectively (step S21). The two images are photographed consecutively at high-speed changing the focus position, but a small position shift has been generated due to camera shaking and subject movement. Therefore even if local areas in the same coordinate position are selected, this means that approximately the same scenes are selected. The local area selected in step S21 corresponds to the ranging target area according to the present invention.

Then in step S22, the feature value in a local area selected for each image is calculated respectively. In concrete terms, variance of pixel values or standard deviation thereof are calculated respectively for the local area which is selected for each image. If the two images are of a same photographic scene, the acquired variance and standard deviation values become higher as the images are more focused, and the variance and standard deviation values become lower as the images are more defocused and blurred. Therefore as a feature value to calculate the degree of blur, variance or standard deviation can be used.

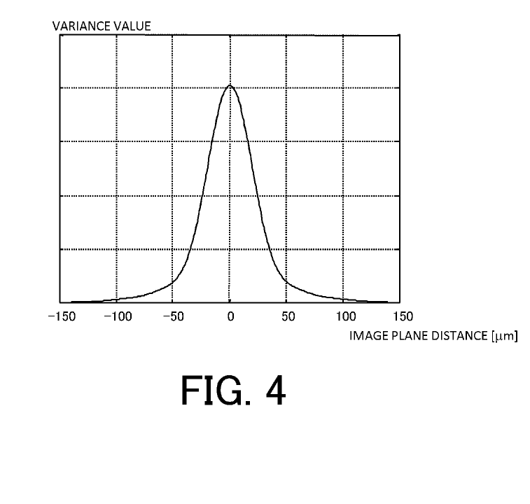

FIG. 4 shows a change of variance of a point spread function (PSF) by defocus (defocus characteristic) in the imaging optical system 10. If the defocus characteristic is extracted from the image, the subject distance can be measured. Variance depends not only on blur but also on the subject, hence the distance cannot be measured by one image alone. Therefore in the imaging apparatus according to this embodiment, the distance is measured by comparing the feature values (variance values) acquired from two images respectively.

In step S23, the ratio of two variance values acquired in step S22 is determined, and a value for estimating the distance (hereafter called “distance dependent value”) is computed from the acquired value. Thereby the change of variance that does not depend on the subject can be extracted. Expression 1 is an expression to determine the distance dependent value d.

Here p_{1,x,y} denotes a local area image of a focused image at coordinates (x,y), and p_{2,x,y} denotes a local area image of a defocused image. i and j are coordinate values of the local area.

The numerator and the denominator in Expression 1 may be interchanged.

$$\begin{matrix}[ Math . 1 ] & \\ d ( x , y ) = \frac{{\sum }_{i , j}^{ } {( {p}_{2 , i , j} - \overline{{p}_{2 , i , j}} )}^{2}}{{\sum }_{i , j}^{ } {( {p}_{1 , i , j} - \overline{{p}_{1 , i , j}} )}^{2}} = \frac{{σ}_{2}^{2}}{{σ}_{1}^{2}} & ( Expression 1 )\end{matrix}$$

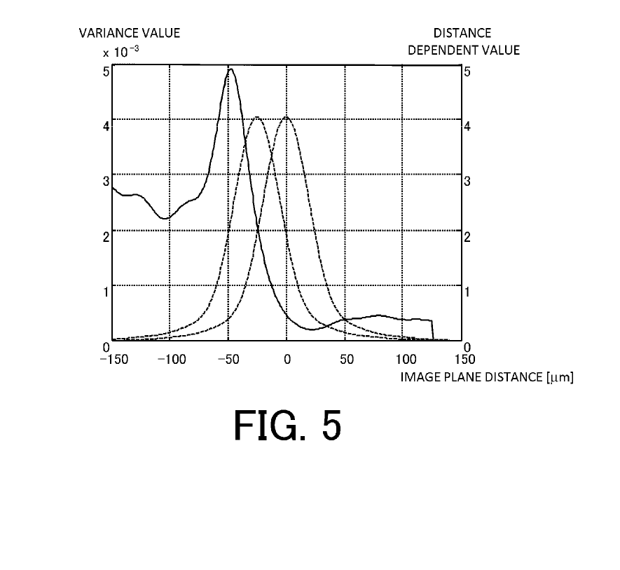

FIG. 5 shows a defocus characteristic of variance of the PSF when the image is focused, a defocus characteristic of variance of the PSF when the image is out of focus, and a ratio of these defocus characteristics (that is, the distance dependent value). The solid line in FIG. 5 is the distance dependent value calculated by Expression 1.

According to FIG. 5, the distance dependent value monotonously changes in the specific section including the focus position (position where image plane distance=0). In other words, the relative position from the focus position on the image plane can be determined based on this value. The distance measuring unit 14 may output the acquired distance dependent value directly, or may convert the distance dependent value into a relative position from the focus position on the image plane, and output the relative position.

The relationship between the distance dependent value and the relative position from the focus position on the image plane differs depending on the F number, therefore a conversion table may be prepared for each F number, so as to convert the distance dependent value into a relative position from the focus position on the image plane. Further, the acquired relative distance may be converted into a subject distance (absolute distance from the imaging apparatus to the subject) using the focal length and a focus distance on the subject side, and outputted as the subject distance.

In this way, the subject distance according to the present invention need not always be an absolute distance to the subject.

The subject distance in the local area can be calculated by the process described above.

In this embodiment, a local area is set a plurality of times throughout the image with shifting one pixel at a time, and the above mentioned process is repeated, whereby the distance map of the entire image is calculated. The distance map need not always have a same number of pixels of an input image, but may be calculated at every several pixels. A location where the local area is set may be one or more predetermined locations, or a location that the user specified via the input unit 16.

According to Embodiment 1, the feature value of the local area is independently calculated for each image, hence even if the positions of the images are shifted somewhat, the feature value does not change much. In the case of determining the distance by cross-correlation, as in the case of the conventional DFD method used for the real space, a position shift may cause a major decrease in correlation, but in the case of this embodiment, the influence of the position shift can be minimized and the distance can be measured accurately.

Particularly if the size of the local area is set to approximately 10×10 pixels, then the influence of the position shift in a sub-pixel unit can be virtually null. Even if one pixel level of the position shift remains, stable distance measurement can be performed without calculating an extreme outlier. If the size of the local area to be selected is increased, the larger position shift can be handled.

### Embodiment 2

Differences of an imaging apparatus according to Embodiment 2 from Embodiment 1 are that the F number, not the focus position, is changed when the photographing parameters are changed, and that the difference, not the ratio, of defocus characteristics is used when feature values are compared. Further, a process to align positions of the two images is additionally executed.

The configuration of the imaging apparatus 1 according to Embodiment 2 is the same as Embodiment 1.

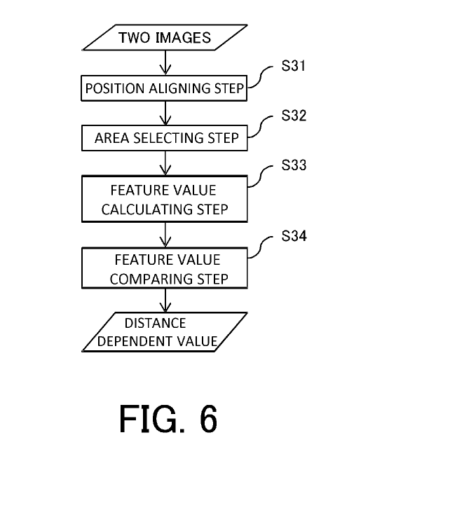

The differences from the process in Embodiment 1 will now be described. FIG. 6 is a flow chart depicting a flow of a distance map generation process according to Embodiment 2.

In Embodiment 2, the F number is changed when the photographing parameters are changed in step S13. In other words, two images having mutually different F numbers are acquired by executing step S14.

The distance map generation process will now be described.

Step S31 is a step of executing a process to align the positions of the two images (hereafter called “position alignment process”). The position alignment can be performed by a conventional method (e.g. position alignment process used for electronic vibration proofing or for HDR imaging), and need not be a process specialized for measuring the distance.

Description on the processes executed in steps S32 and S33, which are the same as steps S21 and S22 in Embodiment 1, are omitted here.

A degree of a blur changes depending on the F number. In concrete terms, as the F number is smaller, the depth of field becomes shallower, and the change of a blur in the defocused state becomes sharper. On the other hand, as the F number is larger, the depth of field becomes deeper and the change of a blur in the defocused state becomes more subtle. In Embodiment 2, the blur is changed by the F number instead of changing the focus position.

In step S34, the difference of the variances calculated in step S33 is determined, and the acquired value is outputted as a distance dependent value. The distance dependent value d is given by Expression 2. Here p₁ denotes a local area image of an image of which F number is small. p₂ denotes a local area image of an image of which F number is large. i and j are coordinate values of the local area, and n is a number of elements in the local area.

$$\begin{matrix}[ Math . 2 ] & \\ d ( x , y ) = \frac{1}{n} {\sum }_{i , j}^{ } {( {p}_{1 , i , j} - \overline{{p}_{1 , i , j}} )}^{2} - \frac{1}{n} {\sum }_{i , j}^{ } {( {p}_{2 , i , j} - \overline{{p}_{2 , i , j}} )}^{2} = {σ}_{1}^{2} - {σ}_{2}^{2} & ( Expression 2 )\end{matrix}$$

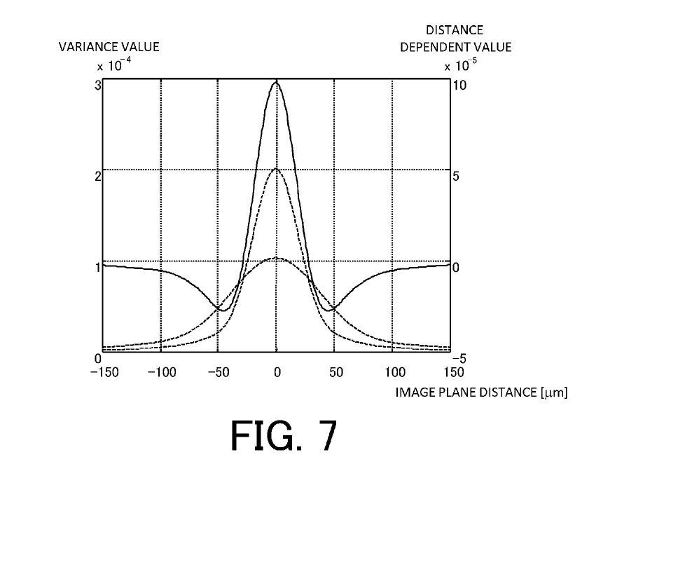

The two graphs indicated by the dotted lines in FIG. 7 are the defocus characteristics of the variances of the PSF respectively, when the images were photographed with two different F numbers. The solid line indicates a difference of the defocus characteristics (that is, the distance dependent value).

According to FIG. 7, the distance dependent value monotonously changes in a specific section including the focus position (position where image plane distance=0). In other words, the relative position from the focus position on the image plane can be determined based on this value. The distance dependent value may be outputted directly, or may be outputted as a relative position from the focus position on the image plane.

According to Embodiment 2, positions of the two images are aligned, whereby a position shift generated by a camera shaking or subject movement during consecutive photographing can be corrected, and the distance can be measured at even higher accuracy. Furthermore the distance, instead of the ratio, is used for comparing the feature values, therefore a dividing circuit is not required, and the apparatus circuits can be downsized.

In this embodiment, the distance measuring unit 14 executes the position alignment, but the signal processing unit 13 may execute the position alignment in advance, and the aligned two images may be inputted to the distance measuring unit 14.

### Embodiment 3

According to Embodiment 3, a predetermined spatial frequency band is extracted by filtering an input image, and the feature values are acquired using the image after the process. For the feature value, the absolute value sum of the pixel values of the local area is used.

The configuration of the imaging apparatus 1 according to Embodiment 3 is the same as Embodiment 1.

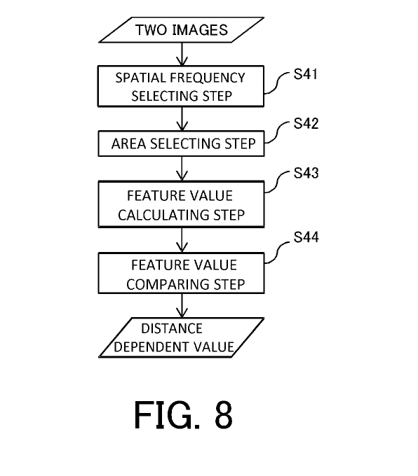

The differences from the process in Embodiment 1 will now be described. FIG. 8 is a flow chart depicting a flow of a distance map generation process according to Embodiment 3.

When an image is inputted to the distance measuring unit 14, only a predetermined spatial frequency band is extracted from this image by a bandpass filter, and the input image is overwritten by the extracted image in step S41. This process is called “spatial frequency selection process”.

Description on the process in step S42, which is the same as step S21, is omitted.

In step S43, the absolute value sum of the pixel values in a local area is independently calculated for two images on which the spatial frequency selection process has been executed.

Then in step S44, the difference (Expression 3) or the ratio (Expression 4) of the absolute value sums calculated in step S43 is determined, and the acquired value is outputted as a distance dependent value. Here p′₁ and p′₂ indicate the local areas of the two images after the predetermined frequency band was extracted. i and j are coordinate values of the local area.

$$\begin{matrix}[ Math . 3 ] & \\ d ( x , y ) = {\sum }_{i , j}^{ } \vert {p}_{1 , i , j}^{′} \vert - {\sum }_{i , j}^{ } \vert {p}_{2 , i , j}^{′} \vert & ( Expression 3 ) \\ [ Math . 4 ] & \\ d ( x , y ) = \frac{{\sum }_{i , j}^{ } \vert {p}_{1 , i , j}^{′} \vert}{{\sum }_{i , j}^{ } \vert {p}_{2 , i , j}^{′} \vert} & ( Expression 4 )\end{matrix}$$

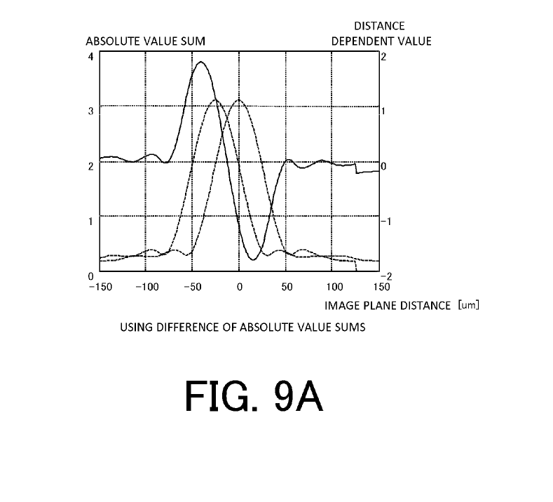

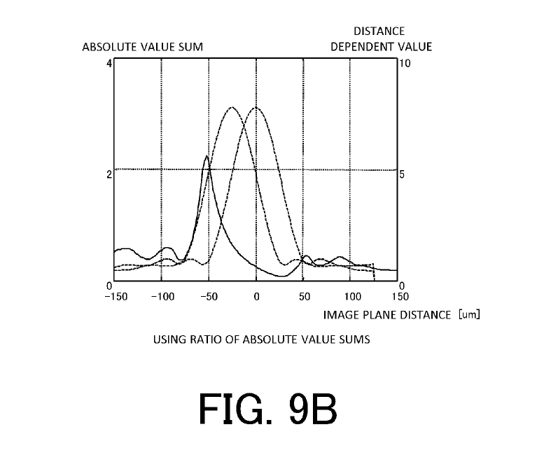

The graphs indicated by the dotted lines in FIG. 9A and FIG. 9B are the defocus characteristics of the absolute value sums of the PSF in the images after the predetermined frequency band is extracted. The solid line in FIG. 9A indicates the distance dependent value acquired by the difference of the absolute value sums, and the solid line in FIG. 9B indicates the distance dependent value acquired by the ratio of the absolute value sums. Just like the other embodiments, the distance dependent value monotonously changes in a specific section including the focus position (position where image plane distance=0), and the relative position from the focus position on the image plane can be determined based on this value.

If a real space image is used for measuring a distance, the change degree of a blur differs depending on the spatial frequency of the image. Whereas in Embodiment 3, the feature values are compared after extracting a predetermined spatial frequency, therefore the distance can be measured at even higher accuracy.

Furthermore by using the absolute value sum of the pixel values as the feature value used for measuring a distance, the computational amount can be decreased compared with the case of using variance. If the difference is used for comparing the feature values, division can be unnecessary. Thereby the circuit scale can be reduced and the imaging apparatus can be downsized.

### Embodiment 4

According to Embodiment 4, the position alignment process and the spatial frequency selection process are added to Embodiment 1. In this embodiment, the distance dependent value is limited to a range of 0 or more and 1 or less.

The configuration of the imaging apparatus 1 is the same as Embodiment 1.

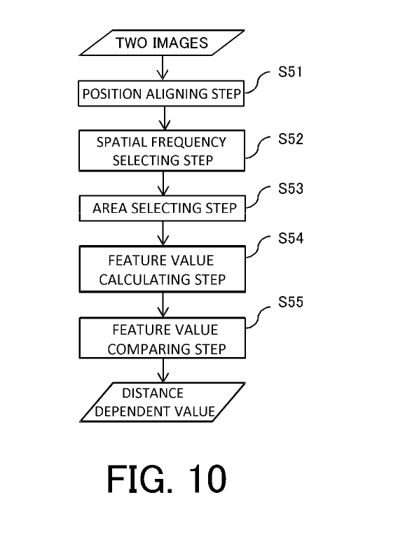

The differences from the process in Embodiment 1 will now be described. FIG. 10 is a flow chart depicting a flow of a distance map generation process according to Embodiment 4.

When two photographed images are inputted, the distance measuring unit 14 executes the position alignment process that is the same as step S31 in Embodiment 2 (step S51).

Then in step S52, the spatial frequency selection process that is the same as step S41 in Embodiment 3 is executed.

In this embodiment, the spatial frequency selection process is executed after the position alignment process is executed, but the sequence is not limited to this, and the position alignment process may be executed after the spatial frequency selection process is executed.

Steps S53 and S54 are processes the same as steps S21 and S22 of Embodiment 1. In other words, in the two images that are inputted, local areas having the same coordinate position are selected, and variance or standard deviation of the pixel values in each local area is calculated independently.

Then in step S55, the ratio of the acquired variances or standard deviations is calculated. In this case, the ratio is determined by setting the greater value as a denominator, and the smaller value as a numerator. Then the distance dependent value can fall within a range of 0 to 1.

Expression 5 is an example when the variance is used, and Expression 6 is an example when the standard deviation is used. In the case of using the standard deviation as shown in Expression 6, however, it is not necessary that the small value always be set as the numerator.

$$\begin{matrix}[ Math . 5 ] & \\ \begin{matrix}d ( x , y ) = \frac{min ( {\sum }_{i , j}^{ } {( {p}_{1 , i , j} - \overline{{p}_{1 , i , j}} )}^{2} , {\sum }_{i , j}^{ } {( {p}_{2 , i , j} - \overline{{p}_{2 , i , j}} )}^{2} )}{max ( {\sum }_{i , j}^{ } {( {p}_{1 , i , j} - \overline{{p}_{1 , i , j}} )}^{2} , {\sum }_{i , j}^{ } {( {p}_{2 , i , j} - \overline{{p}_{2 , i , j}} )}^{2} )} \\ = \frac{min ( {σ}_{1}^{2} , {σ}_{2}^{2} )}{max ( {σ}_{1}^{2} , {σ}_{2}^{2} )}\end{matrix} & ( Expression 5 ) \\ [ Math . 6 ] & \\ d ( x , y ) = \frac{{σ}_{1} {σ}_{2}}{max ( {σ}_{1}^{2} , {σ}_{2}^{2} )} = \frac{min ( {σ}_{1} , {σ}_{2} )}{max ( {σ}_{1} , {σ}_{2} )} & ( Expression 6 )\end{matrix}$$

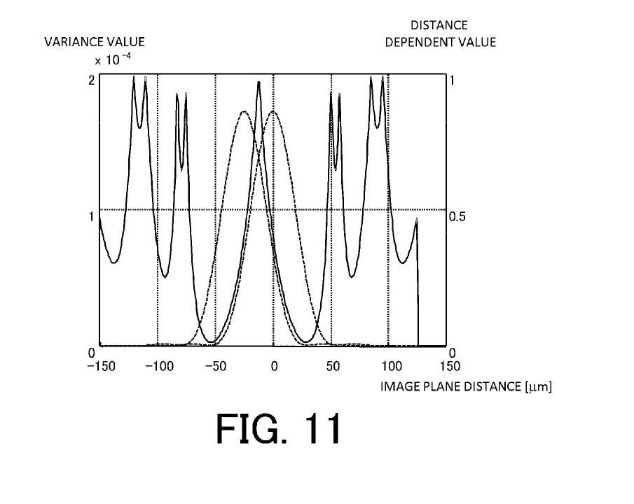

The graphs indicated by the dotted lines in FIG. 11 are the defocus characteristics of the variance of the PSF in the images after the predetermined frequency band is extracted.

According to this embodiment, the calculated distance dependent value d falls within a range of 0≦d≦1, as indicated by the solid line in FIG. 11. Since this value range does not change even if the photographing parameters are changed, the conversion table, which is used when the subject distance is derived from the distance dependent value, can be simplified.

### Embodiment 5

In Embodiment 4, a variance or standard deviation of pixel values is used as a feature value of the local area. In Embodiment 5, however, the computational amount is further reduced by using a square-sum or square root of a square-sum of pixel values.

The differences from the process in Embodiment 4 will now be described.

According to Embodiment 5, the frequency is selected using a frequency selection filter with which the average value becomes 0 in the spatial frequency selection process (step S52). Then if the brightness distribution in the local area does not change much, the average value can be close to 0, and the term to subtract the average value can be ignored in the step of calculating the variance or the standard deviation.

In step S54, one of a square-sum, a square root of the square-sum, and an absolute value sum of the pixel values is calculated in the respective local area, and the ratio or the difference is determined in step S55, whereby the distance dependent value is calculated. To determine the ratio or the difference, the denominator or the subtracted term may be fixed, or the greater one of the two feature values may be set as the denominator or the subtracted term just like Embodiment 4.

According to Embodiment 5, the distance measuring accuracy drops somewhat in an area where the brightness change is conspicuous, but the computational amount further decreases and the distance measuring process can be executed faster.

### MODIFICATION

The above description on each embodiment is merely an example to describe the present invention, and can be changed or combined, as appropriate, without departing from the true spirit and scope of the invention. For example, the present invention may be carried out as an imaging apparatus that includes at least a part of the above mentioned process, or may be carried out as a distance measuring apparatus that has no imaging unit. The present invention may also be carried out as a distance measuring method, or as an image processing program for the distance measuring apparatus to execute the distance measuring method. The above mentioned processes and units may be freely combined to carry out the invention as long as no technical inconsistency is generated.

Each elemental technique described in each embodiment may be freely combined.

For example, the bracket method, the feature value calculation method, the distance dependent value calculation method, the inclusion of the spatial frequency selection process, the inclusion of the position alignment process or the like may be freely combined to carry out the invention.

In the description on the embodiments, an example of the imaging apparatus acquiring two images was described, but three or more images may be acquired. In this case, two images are selected from the photographed images, and the distance is measured. By acquiring three or more images, the range where the distance can be measured is widened, and the distance accuracy improves.

The above mentioned measuring technique of the present invention can be suitably applied to an imaging apparatus, such as a digital camera or a digital camcorder, or an image processor and a computer that performs an image process on image data acquired by the imaging apparatus. The present invention can also be applied to various electronic appliances enclosing the imaging apparatus or the image processor (e.g. including portable phones, smartphones, slate type devices and personal computers).

In the embodiments, the configuration of incorporating the distance measuring function into the imaging apparatus main unit was described, but the distance may be measured by an apparatus other than the imaging apparatus. For example, a distance measuring function may be incorporated into a computer that includes an imaging apparatus, so that the computer acquires an image photographed by the imaging apparatus, and calculates the distance. A distance measuring function may be incorporated into a computer that can access a network via cable or radio, so that the computer acquires a plurality of images via the network, and measures the distance.

The acquired distance information can be used for various image processes, such as area division of an image, generation of a three-dimensional image or image depth, and emulation of a blur effect.

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-167656, filed on Aug. 12, 2013, which is hereby incorporated by reference herein in its entirety.

What is claimed is:

1. A distance measuring apparatus that calculates an subject distance from a plurality of images having different degrees of a blur, comprising:
an area setting unit configured to set ranging target areas in corresponding coordinate positions in the plurality of images, respectively;
a feature value calculating unit configured to calculate, for each of the ranging target areas set in the plurality of images, a feature value of the ranging target area; and
a distance calculating unit configured to calculate an subject distance in the ranging target area based on a plurality of feature values calculated for the ranging target areas.

2. The distance measuring apparatus according to claim 1, wherein
the feature value is at least one of a variance, a standard deviation, an absolute value sum, a square-sum and a square root of square-sum, of pixel values included in the ranging target area.

3. The distance measuring apparatus according to claim 1, wherein
the distance calculating unit is configured to calculate the subject distance in the ranging target area based on a difference or ratio of the feature values in the ranging target areas calculated for the images.

4. The distance measuring apparatus according to claim 1, wherein
the distance calculating unit is configured to calculate the subject distance in the range target area based on a ratio of the feature values in the ranging target areas calculated for the images, and sets the greater one of the feature values as a denominator when determining the ratio.

5. The distance measuring apparatus according to claim 1, wherein
the area setting unit is configured to set ranging target areas in a plurality of positions in an image, and
a distribution of the subject distance in the image is acquired by the feature value calculating unit and the distance calculating unit performing a process on the plurality of ranging target areas.

6. The distance measuring apparatus according to claim 1, wherein
at least one of the plurality of images is an image that is focused on a main subject.

7. The distance measuring apparatus according to claim 1, further comprising
a frequency selecting unit configured to convert the plurality of images into images which include only a predetermined spatial frequency band, wherein
the feature value calculating unit is configured to calculate the feature values using the converted images.

8. The distance measuring apparatus according to claim 1, further comprising
a position aligning unit configured to align positions of the plurality of images, wherein
the feature value calculating unit is configured to calculate the feature values using the images of which positions are aligned by the position aligning unit.

9. An imaging apparatus, comprising:
an imaging optical system;
an image sensor; and
the distance measuring apparatus according to claim 1, wherein
the distance measuring apparatus is configured to calculate an subject distance using a plurality of images acquired by the imaging optical system and the image sensor.

10. A distance measuring method for calculating an subject distance from a plurality of images having different degrees of a blur, comprising:
an area setting step of setting ranging target areas in corresponding coordinate positions in the plurality of images, respectively;
a feature value calculating step of calculating, for each of the ranging target areas set in the plurality of images, a feature value of the ranging target area; and
a distance calculating step of calculating an subject distance in the ranging target area based on a plurality of feature values calculated for the ranging target areas.

11. The distance measuring method according to claim 10, wherein
the feature value is at least one of a variance, a standard deviation, an absolute value sum, a square-sum and a square root of square-sum, of pixel values included in the ranging target area.

12. The distance measuring method according to claim 10, wherein
in the distance calculating step, the subject distance in the ranging target area is calculated based on a difference or ratio of the feature values in the ranging target areas calculated for the images.

13. The distance measuring method according to claim 10, wherein
in the distance calculating step, the subject distance in the ranging target area is calculated based on a ratio of the feature values in the ranging target areas calculated for the images, and sets the greater one of the feature values as a denominator when determining the ratio.

14. The distance measuring method according to claim 10, wherein
ranging target areas are set in a plurality of positions in an image in the area setting step, and
a distribution of the subject distance in the image is acquired by performing a process on the plurality of ranging target areas in the feature value calculating step and the distance calculating step.

15. The distance measuring method according to claim 10, wherein
at least one of the plurality of images is an image that is focused on a main subject.

16. The distance measuring method according to claim 10, further comprising
a frequency selecting step of converting the plurality of images into images which includes only a predetermined spatial frequency band, wherein
the feature values are calculated using the converted images in the feature value calculating step.

17. The distance measuring method according to claim 10, further comprising
a position aligning step of aligning positions of the plurality of images, wherein
in the feature value calculating step, the feature values are calculated using the images of which positions are aligned in the position aligning step.

18. A non-transitory computer readable medium recording a computer program for causing a computer to perform the image processing method according to claim 10.
